(19) United States
(12) Patent Application Publication
(10) Pub. No.: US 2013/0246045 A1
(43) Pub. Date: Sep. 19, 2013

(54) Identification and Extraction of New Terms in Documents

(71) Applicants: Alexander Ulanov, Saint-Petersburg (RU); Andrey Simanovsky, Saint-Petersburg (RU)

(72) Inventors: Alexander Ulanov, Saint-Petersburg (RU); Andrey Simanovsky, Saint-Petersburg (RU)

(73) Assignee: Hewlett-Packard Development Company, L.P., Houston, TX (US)

(21) Appl. No.: 13/420,149

(22) Filed: Mar. 14, 2012

(51) Int. Cl. G06F 17/27

(52) U.S. Cl. 704/9

(57) ABSTRACT

A method and apparatus that can extract new terms from documents for inclusion in a vocabulary collection is disclosed. A document may be parsed to obtain an n-gram phrase indicative of a new term. The phrase may include a plurality of words. The n-gram phrase may be decomposed into a series of bi-gram phrases each including a first and a second phrase part. The first and second phrase parts each include at least one word. It may then be determined whether the first or second phrase part is in a vocabulary collection. If not, it may be estimated as to the probability that the bi-gram phrase should be in the vocabulary collection. The bi-gram phrase may be added to the vocabulary collection if the probability that the bi-gram phrase should be in the vocabulary collection exceeds a minimum threshold level.

### BACKGROUND

Automatic term recognition is an important task in the area of information retrieval. Automatic term recognition may be used for annotating text articles, tagging documents, etc. Such terms or key-phrases facilitate topical searches, browsing of documents, detecting topics, document classification, adding contextual advertisement, etc. Automatic extraction of new terms from documents can facilitate all of the above. Maintaining a vocabulary collection of such terms can be of great value.

### SUMMARY

A method and apparatus that can extract new terms from documents for inclusion in a vocabulary collection is disclosed. A document may be parsed to obtain an n-gram phrase indicative of a new term. The phrase may include a plurality of words. The n-gram phrase may be decomposed into a series of bi-gram phrases each including a first and a second phrase part. The first and second phrase parts each include at least one word. It may then be determined whether the first or second phrase part is in a vocabulary collection. If not, it may be estimated as to the probability that the bi-gram phrase should be in the vocabulary collection. The bi-gram phrase may be added to the vocabulary collection if the probability that the bi-gram phrase should be in the vocabulary collection exceeds a minimum threshold level. The probability calculation may take into consideration a similarity strength and a collocation strength between the first and second phrase part.

### BRIEF DESCRIPTION OF THE DRAWINGS

FIG. 1 illustrates one embodiment of a new term detection system.

FIG. 2 illustrates an example of a tri-gram decomposed into multiple bi-grams.

FIG. 3 illustrates one embodiment of a logic flow in which a document may be parsed for new terms.

FIG. 4 illustrates one embodiment of a logic flow in which n-grams may be decomposed into bi-grams.

FIG. 5 illustrates one embodiment of a logic flow in which a vocabulary collection may be searched.

FIG. 6 illustrates one embodiment of a logic flow in which a probability that a bi-gram should be in a vocabulary collection is determined.

FIG. 7 illustrates a table of results based on an experimental implementation of one embodiment of the new term detection system.

### DETAILED DESCRIPTION

Presented herein is an approach to extract new terms from documents based on a probability model that previously unseen terms belong in a vocabulary collection (e.g., dictionary. thesaurus, glossary). A vocabulary collection may then be enriched or a new, domain specific, vocabulary collection may be created for the new terms. For purposes of this description, a document may be considered a collection of text. A document may take the form of a hardcopy paper that may be scanned into a computer system for analysis. Alternatively, a document may already be a file in electronic form including, but not limited to, a word processing file, a power point presentation, a database spreadsheet, a portable document format (pdf) file, etc. A web-site may also be considered a document as it contains text throughout its page(s).

Current methods of term extraction from within a document often rely either on statistics of terms inside the document or on external vocabulary collections. These approaches work relatively well with large texts and with specialized vocabulary collections. A problem may arise when a document contains cross-domain terms which are essential and a vocabulary collection does not include them.

One approach may be to use more than one vocabulary collection such as a very broad one (e.g., Wikipedia or WordNet) and another more specific one (e.g., Burton's legal thesaurus). Even in this approach two types of terms may not be identified—new terms and term collocations. New terms tend to appear in emerging areas, and established vocabulary collections usually will not catch them. Term collocation refers to a specific term that is used in conjunction with a broader term (e.g., flash drive). It may be difficult to automatically identify if collocated terms are indeed a new term.

The approach presented herein may include a parsing module, a phrase decomposition module, a phrase determination module, and a probability determination module. Each of the modules may be stored in memory of a computer system and under the operational control of a processing circuit. The memory may also include a copy of a document to be parsed as well as a vocabulary collection to be used in new term extraction analysis.

For instance, at a document parsing phase, a document that is readable by a document parsing module in a computer system may have its text parsed such that potential new terms are identified. The new terms may be comprised of phrases of words which may be referred to as n-gram phrases or n-grams.

At a phrase decomposition phase, each n-gram phrase may be broken down or decomposed into several bi-gram phrases. For instance, if n=3, a set of two (2) bi-gram phrases may be decomposed therefrom. The bi-grams include all possible combinations of two part phrases that can be culled from the 3-gram phrase in this instance. Consider the phrase comprised of (a,b,c). This 3-gram phrase can be decomposed into the following bi-gram two part phrases: (a,bc) and (ab,c).

At a phrase determination phase, each of the above identified bi-grams is searched within a vocabulary collection to determine if the one or both of the phrase parts are present in the vocabulary collection. The search may be restricted to vocabulary collection phrases that exhibit a similarity to the bi-gram phrase parts.

At a probability determination phase, bi-gram phrases and vocabulary collection phrases may be subjected to a probability model to determine whether the bi-gram phrases that do not already have an exact match in the vocabulary collection should be added to the vocabulary collection.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

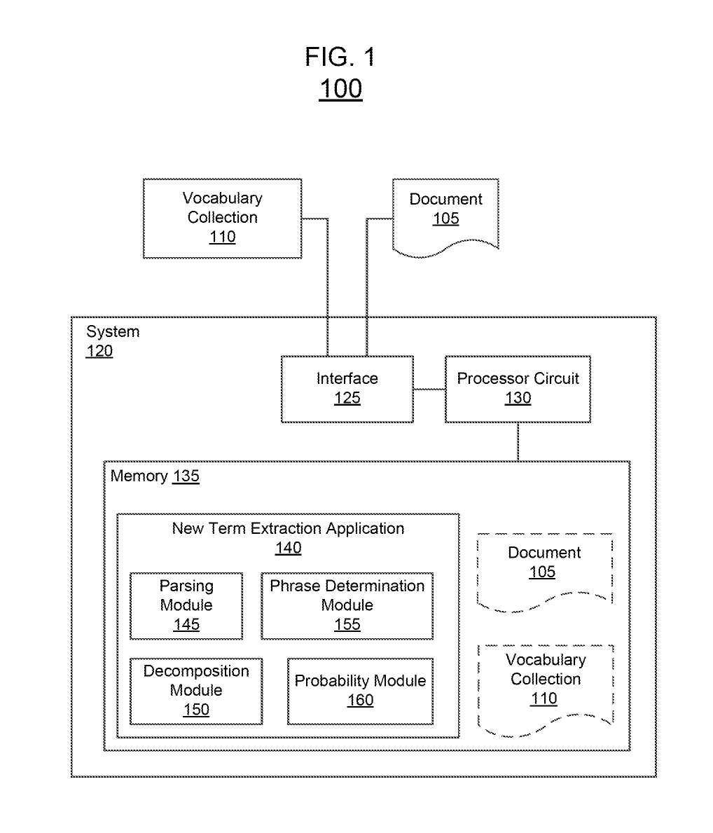

FIG. 1 illustrates a block diagram for new term extraction system 100. A computer system 120 is generally directed to extracting new terms from a document 105 such that a relevant vocabulary collection 110 may be updated or created based on the document 105. In one embodiment, the computer system 120 includes an interface 125, a processor circuit 130, and a memory 135. A display (not shown) may be coupled with the computer system 110 to provide a visual indication of certain aspects of the new term extraction process. A user may interact with the computer system 120 via input devices (not shown). Input devices may include, but are not limited to, typical computer input devices such as a keyboard, a mouse, a stylus, a microphone, etc. In addition, the display may be a touchscreen type display capable of accepting input upon contact from the user or an input device.

A document 105 may be input into the computer system 120 via an interface 115 to be stored in memory 125. The interface 125 may be a scanner interface capable of converting a paper document to an electronic document. Alternatively, the document 105 may be received by the computer system 120 in an electronic format via any number of known techniques and placed in memory 135. Similarly, a vocabulary collection 110 may be obtained from an outside source and loaded into memory 135 by means that are generally known in the art of importing data into a computer system 120.

The memory 135 may be of any type suitable for storing and accessing data and applications on a computer. The memory 135 may be comprised of multiple separate memory devices that are collectively referred to herein simply as “memory 135”. Memory 135 may include, but is not limited to, hard drive memory, external flash drive memory, internal read access memory (RAM), read-only memory (ROM), cache memory etc. The memory 135 may store a new term extraction application 140 including a parsing module 145, a phrase decomposition module 150, a phrase determination module 155, and a probability determination module 160 that when executed by the processor circuit 130 can execute instructions to carry out the term extraction process. For instance, the parsing module 145 may parse the document 105 into n-gram phrases that may be indicative of new terms. The phrase decomposition module 150 may decompose n-gram phrases parsed from document 105 into a series of bi-gram phrases, each bi-gram comprised of first and second phrase parts. The phrase determination module 155 may search each of the above identified bi-grams within a vocabulary collection 110 to determine if the one or both of the phrase parts are present in the vocabulary collection 110. The search may be restricted to vocabulary collection phrases that exhibit a similarity to the bi-gram phrase parts. The probability determination module 160 may apply a probability calculation to determine a probability that a bi-gram or a bigram phrase part belongs in the vocabulary collection 110.

Although the computer system 120 shown in FIG. 1 has a limited number of elements in a certain topology, it may be appreciated that the computer system 120 may include more or less elements in alternate topologies as desired for a given implementation. The embodiments are not limited in this context.

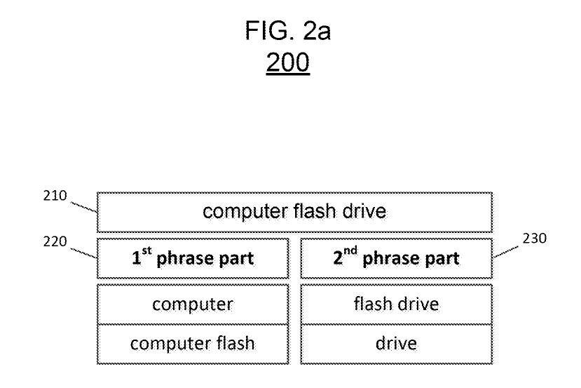

FIG. 2 illustrates an example of a tri-gram 210 (n-gram in which n=3) decomposed into multiple bi-grams. In this example, the tri-gram can be decomposed into two unique bi-grams comprised of a first phrase part 220 and a second phrase part 230. The original tri-gram phrase is “computer flash drive”. The two possible unique bi-gram phrases include (computer flash, drive) and (computer, flash drive).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation

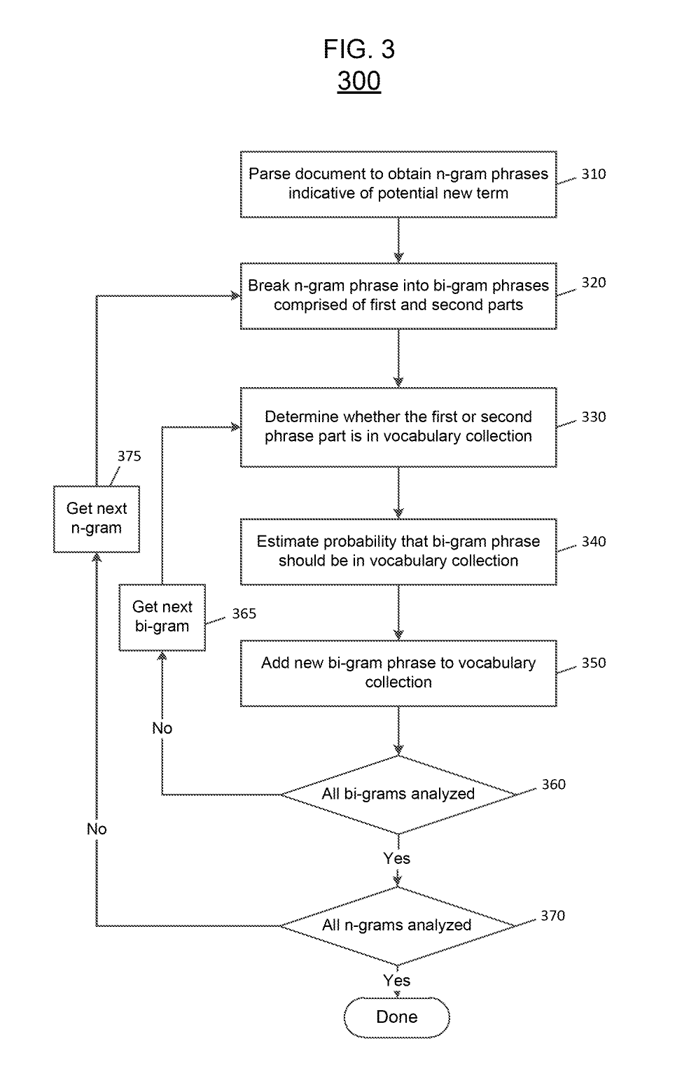

FIG. 3 illustrates one embodiment of a logic flow 300 in which a document may be parsed for potential new terms. The logic flow 300 may identify potential new terms comprised of multi-word phrases (n-grams). The n-grams may be decomposed into a series of unique bi-grams. Each of the bi-grams may be searched against a vocabulary collection 110. The logic flow 300 may be representative of some or all of the operations executed by one or more embodiments described herein.

In the illustrated embodiment shown in FIG. 3, the parsing module 145 operative on the processor circuit 130 may parse the document 105 to obtain n-gram phrases indicative of potential new term at block 310. For instance, the parsing module 145 may read the document and identify various phrases that may appear to be new terms relative to the topic of the document. A new term may comprise multiple words referred to as an n-gram in which “n” equals the number of words in the phrase. The potential new terms (n-grams) may be stored in a part of the memory 135 such as cache or RAM. The embodiments are not limited by this example.

In the illustrated embodiment shown in FIG. 3, the phrase decomposition module 150 operative on the processor circuit 130 may decompose the n-gram phrase into bi-gram phrases at block 320. For instance, the phrase decomposition module 150 may operate on each n-gram phrase to reduce each one to a series of unique bi-gram phrases. The embodiments are not limited by this example.

In the illustrated embodiment shown in FIG. 3, the phrase determination module 155 operative on the processor circuit 130 may determine whether the first or second phrase part is in a vocabulary collection 110 stored in memory 135 at block 330. For instance, the phrase determination module 155 may search the vocabulary collection 110 for phrases in the vocabulary collection 110 that are the same as or similar to the bi-gram phrases. The embodiments are not limited by this example.

In the illustrated embodiment shown in FIG. 3, the probability determination module 160 operative on the processor circuit 130 may estimate a probability that a bi-gram phrase should be in the vocabulary collection 110 at block 340. For instance, the probability determination module 160 may run a probability algorithm comparing the bi-gram phrases with phrases in the vocabulary model to determine a similarity between the bi-gram phrase (potential new term) and the vocabulary collection phrase. The embodiments are not limited by this example.

In the illustrated embodiment shown in FIG. 3, the probability determination module 160 operative on the processor circuit 130 may add the bi-gram phrase to the vocabulary collection 110 at block 350. For instance, the probability determination module 160 may add the bi-gram phrase to the vocabulary collection 110 if the probability that it should be added to the vocabulary collection 110 exceeds a minimum threshold value. The minimum threshold value may be determined in advance and set based on certain factors and considerations including empirical estimation via analyzing the probability values on sample documents. The embodiments are not limited by this example.

In the illustrated embodiment shown in FIG. 3, the probability determination module 160 operative on the processor circuit 130 may determine whether all the bi-gram phrases associated with a particular n-gram phrase have been analyzed at block 360. If not, control is returned to block 330 via block 365 and the next bi-gram associated with the n-gram is analyzed as described above. If all the bi-grams for a particular n-gram have been analyzed then control is sent to block 370 to determine if all the n-grams for the document 105 have been analyzed. If not, control is returned to block 320 via block 375 and the next n-gram in the document 105 is analyzed as described above. The process may repeat until all n-grams identified in document 105 have been analyzed. The embodiments are not limited by this example.

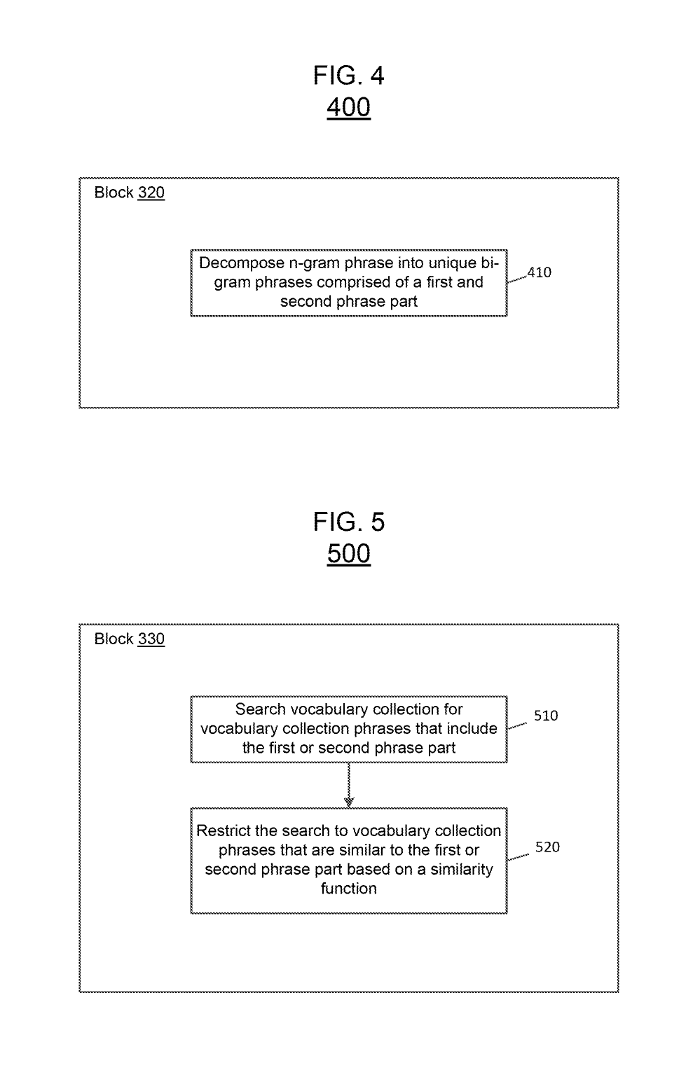

FIG. 4 illustrates one embodiment of a logic flow 400 that is a more detailed explanation of block 320 of FIG. 3 in which n-gram phrases may be decomposed into bi-gram phrases. The logic flow 400 may be representative of some or all of the operations executed by one or more embodiments described herein.

In the illustrated embodiment shown in FIG. 4, the phrase decomposition module 150 operative on the processor circuit 130 may decompose n-gram phrase into unique bi-gram phrases comprised of a first and second phrase part at block 410. For instance, the phrase decomposition module 150 may operate on each n-gram phrase to reduce each one to a series of unique bi-gram phrases. Each bi-gram phrase is limited to two phrase parts, a first phrase part and a second phrase part. The first and second phrase parts are each comprised of at least one word. An example of an n-gram (n=3) phrase decomposed into a series of bi-grams has been illustrated and described above with reference to FIG. 2. The embodiments are not limited by this example.

FIG. 5 illustrates one embodiment of a logic flow 500 that is a more detailed explanation of block 330 of FIG. 3 in which it may be determined whether the first or second phrase part is in the vocabulary collection 110. The logic flow 500 may be representative of some or all of the operations executed by one or more embodiments described herein.

In the illustrated embodiment shown in FIG. 5, the phrase determination module 155 operative on the processor circuit 130 may search the vocabulary collection 110 for vocabulary collection phrases that include the first or second phrase part of the bi-gram phrase at block 510. For instance, the phrase determination module 155 may identify certain phrases in the vocabulary collection 110 that are similar to the bi-gram phrases. The phrase determination module 155 may be looking for bi-gram phrases that share common phrase portions with vocabulary collection bi-gram phrases in the same places. For instance, a document bi-gram phrase may comprise a first phrase portion of “conversion” and a second phrase portion of “units”. The vocabulary collection 110 may include the bigram phrase “conversion dimensions” in which the first phrase part is “conversion” and the second phrase part is “dimensions”. The document bi-gram shares the same first portion as the vocabulary collection bi-gram. Similarly, the vocabulary collection may also contain the bigram phrase “fundamental units” in which the first phrase part is “fundamental” and the second phrase part is “units”. The document bi-gram shares the same second portion as the vocabulary collection bi-gram. The embodiments are not limited by this example.

In the illustrated embodiment shown in FIG. 5, the phrase determination module 155 operative on the processor circuit 130 may restrict the search in block 510 to vocabulary collection phrases that are similar to the first or second phrase part at block 520. For instance, the phrase determination module 155 may use a similarity function to gauge the relatedness of a document bi-gram with a vocabulary collection bi-gram. The embodiments are not limited by this example.

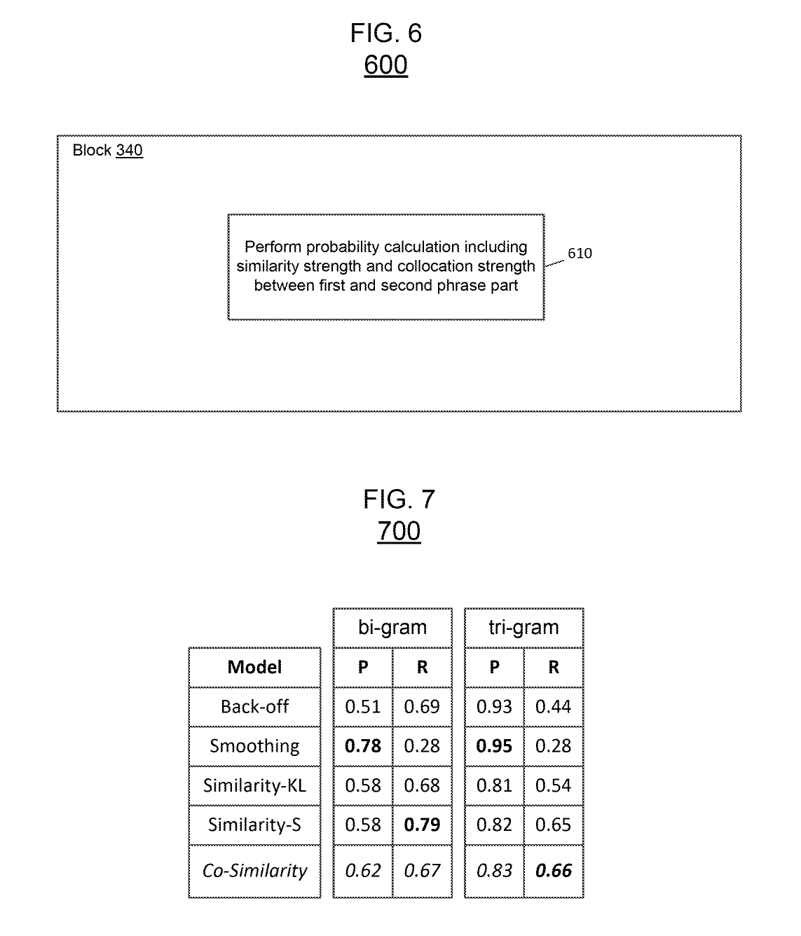

FIG. 6 illustrates one embodiment of a logic flow 600 that is a more detailed explanation of block 340 of FIG. 3 in which a probability calculation is performed. The logic flow 600 may be representative of some or all of the operations executed by one or more embodiments described herein.

In the illustrated embodiment shown in FIG. 6, the probability determination module 160 operative on the processor circuit 130 may perform a probability calculation that considers both a similarity strength and a collocation strength at block 610. For instance, the probability determination module 160 may perform a probability calculation that considers both a similarity strength and a collocation strength between a first and second phrase part of a document bi-gram and a vocabulary collection bi-gram. One example of a probability calculation may be set out below as:

P_{BS}(w₂, w₁)=Σ w′₁,w′₂ P(w₂/w′₁)P(w′₂/w₁)

S(w₁w′₂, w′₁w₂)≧Sₘₐₓ

where
w₁ is the first phrase part from the document bi-gram;
w₂ is the second phrase part from the document bi-gram;
w′₁ is a first phrase part from the vocabulary collection bi-gram;
w′₂ is a second phrase part from the vocabulary collection bi-gram;
S is the similarity function between the first and second phrase parts of the document bi-gram and the vocabulary collection bi-gram; and
P_{BS} is the probability that the first and second phrase parts of the document bi-gram belong in the vocabulary collection.

The embodiments are not limited by this example.

### Experimental Results

Experimental data 700 comparing the term validation model disclosed herein to other term validation models is illustrated in FIG. 7. Four different models were used to test the premise that the present model would be preferable to other models in the case of short documents. An extreme artificial scenario of documents composed of single n-gram phrases that should be either recognized as a term or not were considered. Wikipedia titles and their reversals were used as a collection of documents. A reversal is a phrase presented backwards. For instance, the reversal of the phrase “conversion units” would be “units conversion”. Wikipedia generally aims for comprehensive coverage of all notable topics and will often include alternative lexical representations for such topics. Thus, it may be assumed that if some reversal of a Wikipedia title is a term it should be present among Wikipedia titles. Thus, the titles and reversals collection may be correctly classified into “terms” and “not terms” by lookup into a Wikipedia titles dictionary (vocabulary collection). That classification was used as a gold standard. The testing methodology included splitting the collection into training and test sets and measuring precision (P) and recall (R) of the models when compared to the gold standard.

All article titles from a Wikipedia dump were extracted. The total number of article titles numbered 8,521,847. Among them, there were 1,567,357 single word titles, 2,928,330 bi-gram titles, and 1,836,494 tri-gram titles. The bi-gram and tri-gram titles were filtered out for use in the experiment for the sake of simplicity.

The following four term validation models were compared: a back-off model, a smoothing model, a similarity model, and the co-similarity model of the approach presented herein. The term validation models were each benchmarked using the titles and reversals collection as a vocabulary collection.

The back-off model used the following to estimate the probability that an unseen bi-gram or tri-gram should be in the vocabulary collection.

$${P}_{BO} ( {w}_{m} / {w}_{1}^{m - 1} ) = \{ \begin{matrix}{d}_{{w}_{1}^{m}} \frac{c ( {w}_{1}^{m} )}{c ( {w}_{1}^{m - 1} )} & if c \geq k ; \\ α {P}_{BO} ( {w}_{m} / {w}_{1}^{m - 2} ) & otherwise ,\end{matrix}$$

where w₁^{m} is m-gram, c is the number of occurrences (0 in the present case), α is a normalizing constant, and d is a probability discounting. The back-off model does not address association strength between phrase parts. This is because it uses lower level conditional probabilities. This estimation is quite rough, at least for bi-grams because two words encountered separately in a document may have extremely different meanings and frequencies as compared to when whey stand next to each other in a phrase.

The smoothing model used the following to estimate the probability that an unseen bi-gram or tri-gram should be in the vocabulary collection.

P_{SE}(w₂/w₁)=ρw′₁,w′₂ P(w₂/w′₁)P(w′₁/w′₂)P(w′₂/w₁),

where w₁ and w′₁ are the first phrase parts, and w₂ and w′₂ are the second phrase parts of bi-grams w₁w₂ and w′₁ w′₂.

The similarity model used the following to estimate the probability that an unseen bi-gram or tri-gram should be in the vocabulary collection.

$${P}_{SD} ( {w}_{2} / {w}_{1} ) = {\sum }_{{w}_{1}^{′} ∈ S ( {w}_{1} )} P ( {w}_{2} / {w}_{1}^{′} ) \frac{W ( {w}_{1}^{′} , {w}_{1} )}{{\sum }_{{w}_{1}^{′} ∈ S ( {w}_{1} )} W ( {w}_{1}^{′} , {w}_{1} )} ,$$

where W(w′₁,w₁) is the weight that determines similarity between phrase parts w′₁ and w₁.

For the similarity model two different distance functions to compute the weight that determines similarity between phrase parts w′₁ and w₁ were used. The first similarity model distance function is based on the Kullback-Leibler distance and may be described as:

$${W}_{KL} = {\sum }_{{w}_{2}} P ( {w}_{2} / {w}_{1} ) log \frac{P ( {w}_{2} / {w}_{1} )}{P ( {w}_{2} / {w}_{1}^{′} )} .$$

This term validation model was referred to as “Similarity-KL”.

The second similarity model distance function used may be described as:

W(w₁/w′₁)=ρw₂ P(w₂2/w₁), w₂: ∃w′₂S(w₁w′₂, w′₁w₂)≧Sₘₐₓ.

This term validation model was referred to as “Similarity-S”.

The co-similarity model presented herein used the following to estimate the probability that an unseen bi-gram or tri-gram should be in the vocabulary collection. It uses both similarity and collocation strength.

P_{BS}(w₂/w₁)=Σw′₁/w′₂ P(w₂/w′₁)P(w′₂/w₁), S(w₁w′₂, w′₁w₂)≧Sₘₐₓ.

where S is the similarity function between bigrams. The concept behind the co-similarity model is to find pairs of bi-grams in the vocabulary collection that share common portions in the same places with unobserved pairs of bi-grams. According to the similarity constraint, these bi-grams are from the same domain.

The Wikipedia category structure was employed to measure similarities (S) between terms. For each term a subset of twenty-seven (27) Wikipedia main topic categories (e.g., categories from “Category:Main Topic Classifications”) was extracted. A certain category was assigned to a term if it was reachable from this category by browsing the category tree downward looking in at most eight (8) intermediate categories. Similarity between two terms was measured as a Jaccard coefficient between corresponding category sets as set out below:

$$S ( {term}_{1} , {term}_{2} ) = \frac{\vert {Categories}_{1} ⋂ {Categories}_{2} \vert}{\vert {Categories}_{1} ⋃ {Categories}_{2} \vert}$$

This function is too rough for determining semantic similarity on the given set of categories. However, it is a good and fast approximation for the domain similarity.

Experiments were conducted to measure precision and recall of each term validation model. Wikipedia was split into two parts of equal size using modulo 2 for articles identifiers. Such splitting can be considered pseudo-random because article identifiers roughly correspond to the order in which articles were added to Wikipedia. One part was treated as a set of observed n-grams and was used to train each of the models. The other part was used as a gold standard.

A set was needed on which the gold standard would be a good approximation of the desired behavior of the system. Namely, a set was needed that would be considerably larger than the set of Wikipedia titles while at the same time contain phrases that are unlikely to become Wikipedia titles. Such a set was created by uniting the gold standard bi-grams and tri-grams and their reversals. It was assumed that Wikipedia deliberately decided to include either both or just one of the terms “X Y” and “Y X” into Wikipedia. Thus, it was possible to estimate how good the gold standard can be predicted by each model and how precise it is. Precision (P) was computed in the following way:

$$P = \frac{{N}_{G ⋂ V}}{{N}_{V}}$$

where N_{G∩V} is the number of validated n-grams from the gold standard. Recall (R) was computed as:

$$R = \frac{{N}_{G ⋂ V}}{{N}_{G}}$$

where NG is the number of n-grams in the gold standard.

In the experiment, n-grams were validated by the co-similarity model if the probability estimation exceeded a particular threshold. The threshold was chosen as a minimum non-null probability estimation for an unobserved n-gram.

In brief, incorporating semantic similarity into the probability model allows the term extraction to perform significantly better. As can be seen from the table, the back-off model is very volatile with respect to Wikipedia titles. For bi-grams its unigram setting makes assumptions that are too relaxed, while for tri-grams the back-off model starts to lack statistics.

The smoothing model removes volatility, but appears to be too restrictive lacking recall. This may be because smoothing relies on observation of connecting w₁′w₂′ bi-gram. If the observation probability is replaced with an arbitrary weight 0≦W(w₁′w₂′)≦1, a generalization of the smoothing model and the co-similarity model may be obtained. For the co-similarity model, W may get the values of 0 and 1 depending on the similarity between the bi-grams. The similarity that was used is less restrictive as a smoothing factor than the observation probability. This is reflected by the co-similarity model having a smaller precision but greater recall than the smoothing model.

To compare the co-similarity model with the other similarity model two weighting schemes for the similarity model were considered as previously described. Similarity-KL uses a common approach with Kullback-Leibler divergence. A lack of semantics similarity resulted in similarity-KL performing worse than co-similarity. In similarity-S semantic similarity knowledge was incorporated into the similarity model. The results indicate that the co-similarity model and similarity-S model demonstrate comparable quality with similarity-S outperforming co-similarity for bi-grams and co-similarity outperforming similarity-S for tri-grams.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A method comprising:
parsing a document to obtain an n-gram phrase indicative of a new term, the phrase comprised of a plurality of words;
breaking the n-gram phrase into a bi-gram phrase comprised of a first and a second phrase part, the first and second phrase part including at least one word;
determining whether the first or second phrase part is in a vocabulary collection;
estimating the probability that the bi-gram phrase should be in the vocabulary collection if it is not; and
adding the bi-gram phrase to the vocabulary collection if the probability that the bi-gram phrase should be in the vocabulary collection exceeds a minimum threshold level.

2. The method of claim 1, the breaking the n-gram phrase into a bi-gram phrase comprising:
decomposing the n-gram phrase into all possible unique bi-gram phrases to create multiple first and second phrase part combinations.

3. The method of claim 2, the determining whether the first or second phrase part is in a vocabulary collection comprising:
for each first and second phrase part combination:
searching the vocabulary collection for vocabulary collection phrases that include the first or second phrase part; and
restricting the search to vocabulary collection phrases that are similar to the first or second phrase part based on a similarity function.

4. The method of claim 3, the estimating the probability that the bi-gram phrase should be in the vocabulary collection comprising:
performing a probability calculation taking into consideration a similarity strength and a collocation strength between the first and second phrase part.

5. The method of claim 1, the vocabulary collection comprising a thesaurus.

6. The method of claim 1, the vocabulary collection comprising a dictionary.

7. The method of claim 1, the vocabulary collection comprising a glossary.

8. An apparatus comprising:
a processor circuit;
a memory;
a parsing module stored in the memory and executable by the processor circuit, the parsing module to obtain an n-gram phrase indicative of a new term, the phrase comprised of a plurality of words;
a decomposition module stored in the memory and executable by the processor circuit, the decomposition module to break the n-gram phrase into a bi-gram phrase comprised of a first and a second phrase part, the first and second phrase part including at least one word;
a phrase determination module stored in the memory and executable by the processor circuit, the phrase determination module to determine whether the first or second phrase part is in a vocabulary collection; and
a probability module stored in the memory and executable by the processor circuit, the probability module to estimate the probability that the bi-gram phrase should be in the vocabulary collection if it is not; and add the bi-gram phrase to the vocabulary collection if the probability that the bi-gram phrase should be in the vocabulary collection exceeds a minimum threshold level.

9. The apparatus of claim 8,
the decomposition module to decompose the n-gram phrase into all possible unique bi-gram phrases to create multiple first and second phrase part combinations; and
the phrase determination module to:
search the vocabulary collection for vocabulary collection phrases that include the first or second phrase part for each first and second phrase part combination; and
restrict the search to vocabulary collection phrases that are similar to the first or second phrase part based on a similarity function.

10. The apparatus of claim 9, the probability module to perform a probability calculation taking into consideration a similarity strength and a collocation strength between the first and second phrase part.

11. The apparatus of claim 9, the vocabulary collection comprising one of a thesaurus, a dictionary, or a glossary.

12. An article of manufacture comprising a non-transitory computer-readable storage medium containing instructions that if executed enable a system to:
parse a document to obtain an n-gram phrase indicative of a new term, the phrase comprised of a plurality of words;
break the n-gram phrase into a bi-gram phrase comprised of a first and a second phrase part, the first and second phrase part including at least one word;
determine whether the first or second phrase part is in a vocabulary collection;
estimate the probability that the bi-gram phrase should be in the vocabulary collection if it is not; and
add the bi-gram phrase to the vocabulary collection if the probability that the bi-gram phrase should be in the vocabulary collection exceeds a minimum threshold level.

13. The article of claim 12, further comprising instructions that if executed enable the system to:
decompose the n-gram phrase into all possible unique bi-gram phrases to create multiple first and second phrase part combinations; and
for each first and second phrase part combination:
searching the vocabulary collection for vocabulary collection phrases that include the first or second phrase part; and
restricting the search to vocabulary collection phrases that are similar to the first or second phrase part based on a similarity function.

14. The article of claim 13, further comprising instructions that if executed enable the system to perform a probability calculation taking into consideration a similarity strength and a collocation strength between the first and second phrase part.

15. The article of claim 14, the vocabulary collection comprising one of a thesaurus, a dictionary, or a glossary.
